(19) United States
(12) Patent Application Publication
(10) Pub. No.: US 2008/0059519 A1
(43) Pub. Date: Mar. 6, 2008

(54) System, method, and apparatus for providing storage operations on an online computer system

(76) Inventor: Tony Grifftih, Grand Prairie, TX (US)

Correspondence Address: TONY OLUSEGUN GRIFFITH, 4138 BRIAR HILL DRIVE, GRAND PRAIRIE, TX, 75052, US

(21) Appl. No.: 11/469,854

(22) Filed: Sep. 2, 2006

(51) Int. Cl. G06F 17/00

(52) U.S. Cl. 707/104.1; 707/E17.009

(57) ABSTRACT

An online storage system, method, or apparatus for use on the Internet that allows an individual or computer means to use previously recorded or stored file media for upload to the online storage system. This system, method, or apparatus concurrently provides means to create new media for upload to the online storage system. Said system also provides architecture for providing multimodal user interfaces and tools depending on the interface device type that is used to access the system. This system allows for the dynamic generation of tools for distribution, manipulation, and sharing of content for users of the system.

### FIELD OF THE INVENTION

The present invention relates to computer data and information systems accessed over the Internet, and more particularly to a computer-based system for more effectively allowing users to generate media content for use on the Internet.

### BACKGROUND OF THE INVENTION

Online systems for providing users with methods for storing and sharing creative user generated media on the Internet have grown substantially in popularity and importance. A unique and important property for enabling a user to effectively use these aforementioned systems is upload functionality for enabling a user to select an offline or online previously created media file for storage on the system and use for distribution across the Internet. In addition to online systems for file media storage and management, exemplary of the prior art is:

U.S. Patent application No. 2002/0059120 filed Jan. 22, 2001 and published May 16, 2002 to Milton, James K. et al describes a system for enabling the owner of an electronic device to access a virtual inventory of goods, e.g., media contents such as music, video games and movies. However, said system does not create file media content through a media creation interface, or provide methods by which a user may distribute their stored content on the system through feed syndication or user to user communication methods.

U.S. Patent application No. 2002/0107973 filed Nov. 23, 2001 and published Aug. 8, 2002 to Lennon, Alison Joan et al describes a in which a media browser, operating as a software application on a user terminal or preferably a server for a number of users, provides a user with a single user interface that facilitates browsing and searching different metadata collections over the Internet. A metadata server is associated with each of the metadata collections. When the metadata server receives a request from the media browser, the metadata server interprets the request and replies with a description that satisfies the request and according to a predetermined scheme. The description contains at least one link which represents a return link which represents a return request to the metadata server. Specifically disclosed are methods of forming a table of contents for a particular user preferably based upon media reproduction attributes, methods of right to use and quality of service control, graphical user interfaces for facilitating the browsing process, methods of interpreting metadata, methods of communicating metadata between users, and method for transferring media sessions between users. However said system, does not employ means for the distribution of files between users with a content feeding system, nor does the system employ means for asynchronous and synchronous communication methods for user to user actions.

U.S. Pat. No. 6,351,776 dated Feb. 26, 2002 and U.S. Pat. No. 6,985,927 dated Jan. 10, 2006, U.S. Patent Applications No. 2005/0204020 Filed Mar. 24, 2005 and No. 2005/0204063 Filed Mar. 23, 2005 both patent applications were published Sep. 15, 2005, all to O'Brien et al describe a shared Internet storage resource that provides Internet-based file storage, retrieval, access, control, and manipulation. File instructions and transmissions for storage may be transferred over the Internet to the Shared Resource System. This system provides an “Internet Hard Drive” or “Internet Hard Disk” to and from which files may be stored and retrieved. However, said system does not employ the use of a media creation interface or dynamically generates tools for user distribution of stored file media on the Internet.

U.S. Patent application No. 2003/0182139 filed Jun. 28, 2002 and published Sep. 25, 2003 to Harris, Geoffrey H. et al describes Methods and system for processing media content. A client computer stores a media file and sends an identifier of the media file to a server via a data communication network. In response to the identifier, the server retrieves metadata corresponding to the media file from a central database. The client computer executes a media player program adapted to render the media file and display the metadata, which includes an image file related to the content of the media file. The client computer can also display a thumbnail-sized representation of the image file in its shell to graphically represent the directory in which the media file is located. However, said system does not employ the use of a media creation interface for the direct transfer of media file content to storage within the system and does not employ means for syndication of stored content through a feed distribution system.

U.S. Patent application No. 2004/0133558 filed Jan. 6, 2003 and published Jul. 8, 2004 to DeVorzon, Barry et al., describes a system that utilizes an electronic creation process tool (e-CPT) for the creation of file media for manipulation and storage offline or online. However, said system is designed for the uploading of song ideas to an online storage medium as a central repository. The uses of this central repository is not extended for distribution functionalities with the use of linking and file media feeding systems, nor does this system employ the use of synchronous and asynchronous communication tools for user to user actions.

U.S. Patent application No. 2005/0037740 filed Jul. 25, 2003 and published Feb. 17, 2005 and No. 2005/0018654 filed Jul. 25, 2003 and published Jan. 27, 2005, to Smith, Sunny P. et al describes a multimedia content interface system, computer program product, and method of operation provides multimedia content to a user without the user having to use a computer system, or other computation device. A multimedia content interface system for providing multimedia content stored on a data communications network to an end-user over another network, the multimedia content interface system communicatively connected to the data communications network and the other network. However, said system does not provide interfaces for the creation of file media content, nor does the system employ means for asynchronous and synchronous communications for facilitating the notification of users to new content media and other user actions.

U.S. Patent application No. 2004/0199604 filed Sep. 30, 2003 and published Oct. 7, 2004 to Dobbins, Kurt A. et al describes methods and systems for identifying and preferring certain content transmission over others for transport in a multiple subscriber computer network, such as public broadband access network. The participating content transmission are identified on a number of bases including by sending or receiving application, or by use of tags embedded by the content originator, sender, or distributor. These tagging techniques are also usable to enforce the content owner's distribution rights. However, said system does not employ the use of asynchronous and synchronous communications means for facilitating the notification of users to new content media and other actions.

U.S. Pat. No. 6,651,141 dated Nov. 18, 2003 to Adrangi et al, describes a system and method for caching files is disclosed. Popularity values are calculated for a plurality of files over a period of time. The popularity values are then used to determine which files should be cached at various remote sites. Once the caches are filled, the popularity values associated with the cached files are periodically compared with the popularity values of uncached content. Generally, if the popularity of an uncached file is greater than the popularity of a cached file, then the cached file will be replaced. However, numerous different variables may be factored into the caching determination including, for example, the size of the file, the required bitrate of the file, the identity of the owner of the file, and/or the type of file. In contrast, this system does not include integration of media creation interfaces that enable the generation of file media content for online storage, and this system does not incorporate means for offering associated code for distribution with linked information derived from file media content stored on the system.

U.S. Patent application No. 2005/0138305 filed Dec. 17, 2003 and published Jun. 23, 2005 to Zellner et al relates to a system for providing information storage services to a service application user via a service provider. This method includes presenting options to service application user operable for specifying a duration of time for storing an information element at a remote location; receiving a selection from a service application user in response to presented options; and assigning a storage period to said information element based upon said selection. However, this system does not aggregate a media creation interface and an upload interface and does not provide the user with methods for distribution of stored file data.

U.S. Pat. No. 6,697,792 dated Feb. 24, 2004 to Bunney et al. Describes a method for distributing information that comprises at least one content source, at least one client, a communication network, a distribution server, and a profile database associated with the distribution server. However, said system is not involved in the processes of content creation for the content source through a media creation interface for the system user and does not embody multimodal architectures for flexibility across various systems that can access information online.

U.S. Patent application No. 2005/0223277 filed Mar. 23, 2004 and filed Oct. 6, 2005 to Ballard, Clinton L. et al, describes an online storage system where files from a client are backed up over the Internet or to a back-up storage medium. However said system incorporates the use of online storage for back-up purposes not online storage for distribution and sharing purposes that extend the back-up functionalities. Furthermore, said system does not include an interface for creation of media that is concurrent with the system's ability to allow a user to back-up files through a file uploading facility.

U.S. Patent application No. 2006/0031770 filed Aug. 5, 2004 and published Feb. 9, 2006 to McMenamin; Marie et al., describes a system and storage mediums for providing multi-media content storage and management services. From a single user interface, the method includes creating a library of media content, creating at least one other content item including at least one of a web page, newsletter, message board, email, instant message, chat room text message, and electronic greeting, associating at least one component of the library with at least one other content item to form an arrangement. The access restrictions include the option of applying no restriction. However, there is no use of feeding systems for distributing stored content on the system across the Internet.

U.S. Patent application No. 2006/0095337 filed Oct. 31, 2004 and published May 4, 2006 to Morgan, Jeffery A. describes a solution for spontaneous sharing between a sharer and a recipient device of a media asset reference for a media asset purchased through a media service by a user of the sharer device using a short-range wireless protocol. However, said system does not include a media creation interface that allows a user to create the purchasable file media asset references described and said system does not embody content distribution mechanisms through syndication feeds or user to user communication tools,

U.S. Patent application No. 2006/0106898 filed Nov. 17, 2004 and published May 18, 2006 to Frondozo; Rhea Reyes et al., describes a system for storing and using metadata in multiple storage locations. Signature data is stored in a system storage indicating a plurality of metadata copy locations, each locally identifying a storage device and a copy location with the storage device. However, said system does not incorporate a media creation interface for uploading new file media into the system. This system also does not provide a hyper-text link information system with the purpose of providing a user with various functions for content distribution and sharing.

U.S. Pat. No. 6,834,289 dated Dec. 24, 2004 to Kaneda et al, describes a plurality of storages having respective attributes and a method for preserving data is provided in consideration of the attribute (performance or cost) and the operation ratio of the storage and the using frequency of the data in the storage area network. This system includes a local management unit for managing locations of stored data. This location management unit duplicates and moves data between storages based on the operation ratio of the storage, the access frequency of the data, the control information and the billing information. However, this system does not include file media creation interfaces that generate file media content for storage.

U.S. Pat. No. 6,839,743 dated Jan. 4, 2005 to Shim describes a web drive system that integrates storage spaces provided by multiple Internet sites into a single imaginary drive usable as storage of a mobile terminal. The web drive system includes: a web drive interface for connecting a mobile terminal controller to an imaginary drive to form a web drive; a user information manager for managing user information necessary to have access to the individual Internet sites; a user information storage for storing the user information; an Internet site interface for automatically logging onto the individual Internet sites; a storage space integration manager for managing the information data to be stored/restored; a space allocation information storage for storing space allocation information indicating the capacity of the storage space of the web drive and the location of the Internet site that stores the information data; and a storage mode selector for selecting the mode of storing the information data. However, this system does not provide means for the syndication of file media content through a feeding system.

U.S. Pat. No. 6,850,255 dated Feb. 1, 2005 to Muschetto et al, describes a GUI containing a panel along each of its edges is produced within a computer's display. Each of the four panels are always visible and accessible within the GUI and contain items that display or reference network-based information, communication, navigational systems, computer programs, and other items. These items have been assigned to the panels based upon a hierarchal containment system which, in the preferred embodiment of the invention, uses the categories “people, places, things, and home” as its first logical grouping of the various items and services a user would seek to utilize within the GUI. This organizational system, and its associated visual representation within the panels, enables the GUI to be displayed and operated within multiple computer devices, even though the designs of those devices may include a wide range of display and control systems. This consistency across various computing devices enables a user to quickly apply knowledge gained from having used the GUI on another computing device. Furthermore, the items presented within the GUI, as well as the GUI's configuration, are stored in, and retrieved from, a networked “server” computer thereby enabling a user to produce and access their familiar GUI workspace and items using a variety of networked computer devices. The GUI therefore may be accessed within multiple computing devices and provide access to information, computer programs, and electronic communications. However, this system does not provide a means for the integration of file media creation interfaces for the direct transfer of new content to system storage, and this system does not provide means for distribution of the file media content through feeding systems.

U.S. Patent application No. 2005/0193016 filed Feb. 17, 2005 and published Sep. 1, 2005 to Seet, Nicholas; et al describes a system for the generation of a media content database by correlating repeating media content in media streams. This system involves a media content database that is created and maintained by comparing the media items from two related media streams. A reviewer observes the matched samples representing the repeating content and provides identifying meta-data for that content. The identified media content is then added to the media content database, where it can be used at a later time in an application that requires media content recognition. However, said system does not employ means for the creation of content that comprises the matched media streams through a media creation interface.

U.S. Patent application No. 2005/0249139 filed Mar. 2, 2005 and published Nov. 10, 2005 to Nesbit, Peter describes a system for delivering broadcast and communications services, wherein said services comprise provision of one or more Internet media streams comprising Internet audio streams and Internet video streams, Internet data comprising world-wide-wed and email, telecommunications; However, said system does not provide means for creating content distributed in the said Internet media streams nor does the system provide a means for synchronous and asynchronous communications between a plurality of user to user actions.

U.S. Patent application No. 2006/0155762 filed Jul. 1, 2005 and dated Jul. 13, 2006 to Lee, Prescott V. et al describes an online system for single act media sharing. Where said system comprises receiving a media selection from a user. In response to a single act preformed by the user, a first loop with an identifier is modified based on the media selection. The same identifier is assigned to the media selection. The media selection is forwarded to a server that updates at least one second loop associated with one or more other users with the media selection based on the identifier in the response to the single act performed by the user. However, said system does not provide asynchronous and synchronous means by which enable user to user actions that compliment the methods for automatic distribution of content.

U.S. Patent application No. 2006/0047767 filed Sep. 7, 2005 and published Mar. 2, 2006 to Dodrill, Lewis Dean et al describes a unified messaging system using web based application server for management of messages using standardized servers. This system involves the generation of audio encoded media file through a media creation interface and the storing of that media file for later access; however, said system does not employ means for the syndication of stored media content through a feeding system.

U.S. Pat. No. 6,956,833 dated Oct. 18, 2005 to Yukie et al, describes a method and system for remotely storing data on a server through a wireless connection instead of storing data locally in a consumer device, as well as devices for use with the method and system. More particularly, a video camera, still camera, laptop computer, or other consumer device which normally stores data in local memory such as film, disk, random access memory, memory sticks, or other forms of storage would transmit the data to a remote server through a wireless connection. The data would be saved on the remote server for subsequent retrieval through, for example, the Internet or a wireless connection to the server. In addition, data not originating from the user device could be downloaded to the consumer device. The data to be retrieved can be specified by the user, or sent to the user according to a user profile stored on the server. However, this system does not provide a means for the syndication of user content stored on the system through a feeding distribution system. Furthermore, this system does not provide asynchronous and synchronous communication methods for user to user actions.

U.S. Patent application No. 2006/0159109 filed Dec. 16, 2005 and published Jul. 20, 2006 to Lamkin, Allan B. et al, describes a system for use in managing content on at least a local network. Some embodiments provide a method for use in managing content that detects there is a change to content on a local network, determines whether the change is additional content on a first client device, determines whether the additional content can be identified, and determines whether there is a predictive distribution scheme when the additional content is identified, and distributes the additional content over the local network. However, said system may involve the processes of manipulating stored content for distribution over networks, said system does not address processes for creation of media or asynchronous and synchronous communication methods for sharing that media through user to user actions.

U.S. Patent applications No. 2006/0129907, No. 2006/0129917, and No. 2006/0129916 all filed Dec. 1, 2005, and published Jun. 15, 2006 to Volk, Andrew R. et al. describe systems for adding descriptive information to a Real Simple Syndication (RSS) document. The descriptive information describes the content of media objects syndicated through the document. The descriptive information can be used to provide additional information to a subscriber, and can be used in searching for syndicated media content. However, said system employs a system for writing a document for distribution of content and does not provide means for creation of content to be distributed. Furthermore, said system is narrow in scope in that it describes a particular document format for syndication of media, while there are currently other formats for syndicating media such as the Atom document format, which applies to a pair of related standards being the Atom Syndication Format, and the Atom Publishing Protocol (APP). This system is feed document type dependant.

U.S. Pat. No. 7,010,532 dated Mar. 7, 2006 to Stakutis et al, describes implementations for improved access to information stored on a storage device. A plurality of first nodes and a second node are coupled to one another over a communications pathway, the second node being coupled to the storage device for determining meta data including block address maps to file data in the storage device, and the first nodes being configured for accessing file data from the storage device using said meta data, wherein at least one first node caches data including meta data for a file accessed by said first node. A file application on said first node is configured to get requested file data by accessing said cached data for the file. A file notification system sends a file change notification to said first node indicating changes affecting the cached data, wherein the file application on the first node inspects the change notification to determine whether to get the requested file data directly using said cached data, whereby file accesses may be effected for an extended time with data locally cached at first nodes of the system. However, this system does not include the integration of file media creation interfaces for the creation of new file media and does not incorporate a system for distribution of file media through feed content streams.

U.S. Pat. No. 7,042,440 dated May 9, 2006 and U.S. Patent Application No. 2002/0036617 Filed Aug. 21, 1998 to Pryor et al describes affordable methods and apparatus for inputting position, attitude (orientation) or other object characteristic data to computers for the purpose of interfacing with computers. Invention uses electro-optical sensors, and particularly TV Cameras, providing optically inputted data from specialized datum's on objects and/or natural features of objects. However, said system does not employ the use of feeding systems for distribution of the content created by the Man machine interface, nor does that system provide a means for hyper-text link information that enables linking to stored media content online.

http://www.revver.com cited Jul. 1, 2006 is a website in which a user is allowed to upload and share video content through the use of a downloadable client. System employs use of advertising watermarks appended to uploaded videos to provide advertising revenues to the content creators. However, said system does not employ the use of media creation interfaces, or the use of dynamic feed generation tools for a user's stored media content.

http://www.Guba.com. cited Jul. 1, 2006 is a website in which a registered user of the website is able to upload and share video file media content on the system. However, said system does not employ the use of a media creation interface or dynamically generated feeds from user content media stored on the site.

Http://www.streamload.com. cited Jul. 1, 2006 is a website in which a registered user of the website is able to upload previously created file media content for download, use, and distribution across the Internet. However, said web system does not incorporate a media creation interface for creation of new file media content for upload on the system.

Http://www.openomv.org cited Jul. 1, 2006 is a website in which a registered user of the website may upload file media for storage, use, and distribution across the Internet. This site also incorporates functionality for creating applications that interact with the website system through provided custom API's. However, this application does not provide a media creation interface for constructing new file media to be uploaded onto the system. Furthermore, this application does not dynamically generate feeds for sharing or distribution of upload file media across the Internet.

http://www.videoegg.com cited Jul. 1, 2006 is a website in which a registered user of the website is able to upload a previously created video or media file for distribution and upload to certain destination sites, and web logs. However, said system does not allow for dynamic feed generation into a users content library as an option.

http://www.vimeo.com cited Jul. 1, 2006 is a website that allows a registered user to upload, share, and search for file media content on the system. Said system allows the tagging of uploaded file media content to facilitate the organization, searching, and accessibility of media content provided by users of the system. However, said system does not employ the use of media creation interfaces or provides a means by which media may be distributed through feeds and content syndication.

http://www.hipcast.com. cited Jul. 1, 2006 is a website that allows a user to create, and upload audio and video for distribution to websites and supplement the destination website's content. Said system employs use of feeds for deploying web casts to electronic media devices, however, this system does not expand on the feed capabilities by allowing feed generation of stored user content on the system. However, said system does not employ the use of a synchronous communications tool to provide the ability for sharing media through user to user actions.

http://www.photobucket.com cited Jul. 1, 2006 is a website in which a registered user of the website is able to upload previously created video media or photo media files for distribution and use across the Internet. However, said website does not incorporate the use of a file media creation interface as an option on the system as well as the normal upload functionality.

http://www.veoh.com cited Jul. 1, 2006 is a website in which a registered user of the website is able to upload high quality video for publish and tailors its service as a form of “Internet Tv”. However, said system does not employ the use of a media creation interface for onsite file media creation.

http://www.jusspress.com cited Jul. 1, 2006 is a website in which a registered user of the website is able to upload photos or videos to share and distribute to family and friends. This site boasts a chat interface, media creation interfaces for media content comments, and publishing of media content to blogs. However, this system is site and destination specific and limiting in regards to the way in which content is distributed, and does not dynamically generate feeds that allow for people to directly subscribe to a user's uploaded content.

http://www.flickr.com. cited Jul. 1, 2006 is a website in which a registered user of the website is able to upload pre-created photo media files for distribution and use across the Internet. However this system does not provide the user a file media creation interface for uploading files in conjunction with the normal upload functionality.

http://www.grouper.com cited Jul. 1, 2006 is a website in which a registered user of the website is able to upload, share or create videos for publishing, storage or distribution. This site contains tools for creation of media on the site, feeding systems for providing distribution of media and other publishing tools. This system does provide an email invitation interface for asynchronous communications with other peers, however, said system does not employ the use of a synchronous communications tool to provide the ability for sharing file media through user to user actions.

http://www.vmix.com cited Jul. 1, 2006 is a website in which a registered user of the website is able to upload and share video media files. However, said system does not employ the use of media creation interfaces.

http://www.youtube.com cited Jul. 1, 2006 is a website in which a registered user of the website is able to upload pre-created video media files for distribution and use across the Internet. However, does not allow the user to create file media for upload through a media creation interface on the system and does not incorporate asynchronous and synchronous communication methods for sharing media through user to user actions.

Http://www.ourmedia.org cited Jul. 1, 2006 is a website in which a registered user of the website is able to upload pre-created video, photo, or audio media files for distribution and use across the Internet. However, said system does not provide a file media creation interface that facilitates in skipping the transfer of files from an offline or online file system and extends the normal upload functionality of the system.

### SUMMARY OF DISCLOSURES

Accordingly, the invention provides a file media storage management information system, including:

A system including a server computer and a database of users and media files that stores for each user associations to said media files, whose contents, or location information (i.e. Pointers) are stored in a database.

The database provides a means for managing a user's stored related media files through retrieval, update, removal, or creation methods. This database stores the descriptive user data of user's and their respective related stored media and that media's descriptive information, media, and user data.

Methods for providing multimodal user interfaces and accessibility dependant on the interface device type(s) that accesses the system.

An interface for the creation of media content that is uploaded into the database by the upload functionality of the interface, upload functionality of the system, or other means.

An interface for the uploading of previously created media content that may be used to browse, search, or modify a file system to upload the file media content into the database.

A hyper-text link information system for allowing a registered user to receive information about hyper-text link information related to an associated file media, and displaying a means by which the user may use that hyper-text link information for use on other online, Internet, or WWW documents. Herein lies the following processes but is not limited to:

Within the user interface system a hyper-text link is created from retrievable information stored in the database about the uploaded file media, in which the user(s) may use that link to externally access the media file for public or private use. Within the user interface system a hyper-text link is created from information stored in the database about a said media file(s) where that hyper-text link may be a feed by which individuals may be automatically updated to changes in media content(s) stored on the system.

Wherein said system incorporates means for distributing user generated media content, through manual and automatic feed and syndication methods, manual and automatic publishing methods, and synchronous and asynchronous communications methods on the system.

### BRIEF DESCRIPTION OF THE DRAWINGS

FIG. 1 shows a block diagram of the components of a system for user to create, upload, maintain, distribute or share media files on-line in accordance to one embodiment of the invention.

FIG. 2 provides an illustration of a block diagram that embodies model architecture for a multimodal interface and presentation on an online system depending on device type access.

FIG. 3a provides an illustration for an asynchronous communication interface tool modeled as a send email form.

FIG. 3b provides an illustration for a synchronous communication interface tool modeled as an instant messaging chat client.

FIG. 4 provides an illustration for an interface that allows the user to add descriptive information to a media file for upload, in accordance with one embodiment of the invention

FIG. 5 provides an illustration for an interface that allows a user to upload pre-stored media off of their client side file system in accordance with one embodiment of the invention

FIG. 6 provides an illustration for an interface that allows user creation of media files for direct on-line transfer to a storage medium in accordance with one embodiment of the invention

FIG. 7 provides illustration for hyper-text link information system and components in accordance with one embodiment of the invention.

FIG. 8 provides an illustration for the flow logic of Hyper-text link information system in regards to maintenance, manipulation, and distribution of stored files in accordance with one embodiment of the invention.

FIG. 9 provides an illustration of the flow logic for the removal of files stored on the system in accordance with one embodiment of the invention.

FIG. 10a provides an illustration of a model flow for manual publishing of information for stored content and accessing of that store content on another Internet document or online document.

FIG. 10b provides an illustration of a model flow for automatic publishing of information for stored content and accessing of that stored content on another Internet document or online document.

FIG. 11 provides a flow summary for the overall operation of the system in accordance with one embodiment of the invention.

### DESCRIPTION OF THE SPECIFIC EMBODIMENTS

Embodiments of the invention are described herein in the context of a system, method, and apparatus for providing creation, storage, management, maintenance, sharing and distribution of user generated file media content on an on-line computer system. The following detailed description of the invention is illustrative only and is not intended to be in any way limiting and those of the ordinary skill in the art will realize that. For skilled persons having the benefit of this disclosure, other embodiments of the invention will readily suggest themselves to such skilled persons. Detailed implementations of the invention as illustrated in the accompanying drawings will now be referenced. The same reference indicators will be used throughout the drawings and the following detailed description to refer to the same or like parts.

In the interest of certainty, not all of the routine features of the implementations as described herein are shown and described. It will, of course, be appreciated that in the development of any such actual implementation, numerous implementation-specific decisions must be made in order to achieve the developer's specific goals, such as compliance with application- and business-related constraints or requirements, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In conformity with the invention, implementation of the process steps, components, and/or data structures may be implemented using various types of operating systems, computing platforms, computer programs, and/or general purpose machines. Also, those of ordinary skill in the art will recognize that devices of a less general purpose nature, such as hardwired devices, programmable semiconductor devices and the like, may also be used without departing from the scope and spirit of the inventive concepts disclosed herein.

### DEFINITIONS

Interface. Any mechanism by which an external individual or external computer can obtain and provide data, respectively to or from the database of the present invention. A common example of an interface is a web site. Other examples may include an e-mail message, a telephone voice message, a recorded video message, or a paper report and the like.

Multimodal Web System. This defines an online system that employs means by which a web site or interface may handle a plurality of inputs and their specific functions dynamically to take advantage of the different integrated or interactive functions provided by a particular input device.

Hyper-Text Link Information System (HTLIS). Interface that provides dynamically generated hyper-text links, feed files, and associated code for maintenance, distribution, and sharing of stored file media in the invention. This interface serves the purpose of streamlining and integrating operations and functionalities that enable easy user distribution of file media.

Media Creation Interface (MCI). Interface that allows an external individual or external computer the ability to create, edit, or provide any means to author file media and the like for transfer to the system.

Feed. A method by which content may be distributed to individuals or computers on the Internet dynamically. Many news-sites, forums, and blogs, currently use feeds in the form of RSS or ATOM file formats to update users to current news headlines, new forum topics, and new blog entries. A feed may also be comprised of technologies that communicate with electronic media devices. Current examples of these are small media devices that receive these feeds as broadcasts i.e. the Apple Computer's iPod's “podcasts”.

Web Site. A computer system that serves informational content over a network using the standard protocols of the World Wide Web. As used herein, the term is generally intended to encompass both (i) the hardware/software server components that serve the informational content over the network, and (ii) the “back end” hardware/software components, including any non-standard or specialized components, that interact with the server components to perform services for web site users.

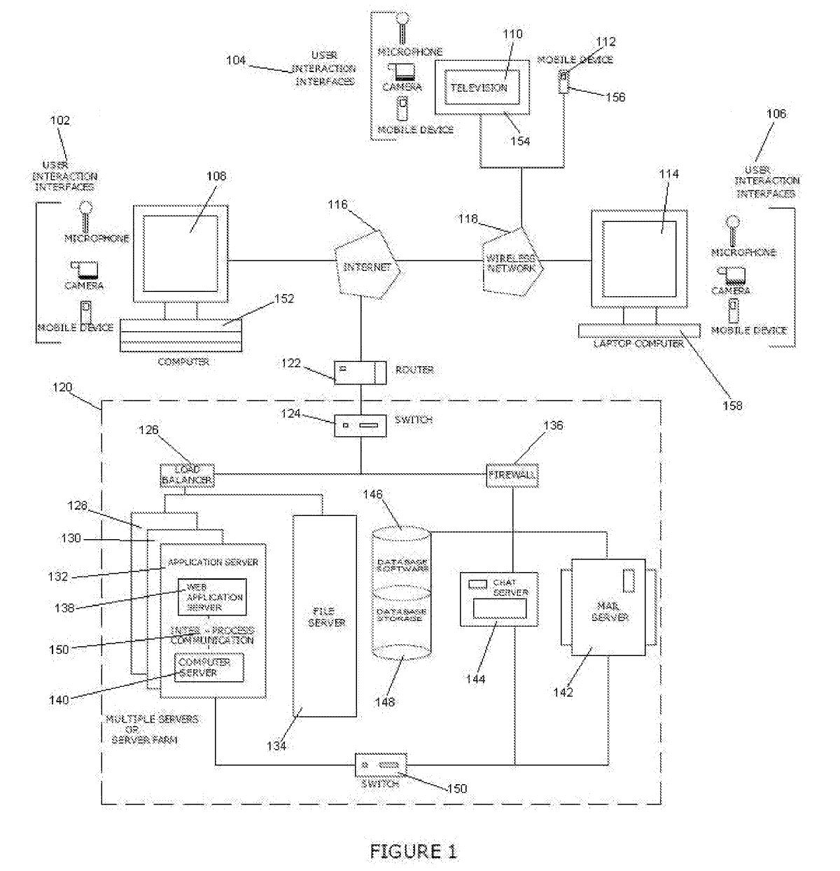

FIG. 1 illustrates a general depiction of the architecture of a system that operates in accordance with one embodiment of the invention. As shown in FIG. 1, a plurality of graphical user interface (GUI) displays 108, 110, 112, and 114 are presented in coordination with a plurality of user interface devices 152, 154, 156, and 158 as well as, user interaction interfaces 102, 104, and 106 connected to an apparatus 120 via the Internet 116 or through a wireless network 118. The user interfaces 152, 154, 156, and 158 may be any device capable of presenting data or facilitates in creating data, including, but not limited to, mobile computers, mobile communications devices, televisions sets or hand-held “personal digital assistants”. The user interaction interfaces 102, 104, and 106 may be any device capable of facilitating the creation of data, including, but not limited to, cameras, microphones, and other mobile devices capable of data creation. As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 1 is for expressive purposes only. Although the description may refer to terms commonly used in describing particular public networks such as the Internet, the description and concepts equally apply to other public and private computer networks, including systems having architectures dissimilar to that shown in FIG. 1. For example and without limitation thereto, the system of the present invention can find application in public as well as private networks, such as a closed university system, or the private network of a company.

The apparatus 120 is connected to the Internet 116 through router 122 and switch 124. As us well known in the relevant art(s), routers forward packets between networks. The router 122 forwards information packets between the apparatus 120 and devices 152, 154, 156, and 158, as well as devices, 102, 104, and 106 over the Internet 116. Load balancer 126 balances the traffic load across multiple mirrored servers 128, 130, 132, and firewall 136 provides protection from unauthorized access to the apparatus 120. The switch 124 may act as a gatekeeper to and from the Internet 116. The components appearing in the apparatus 120 refer to an exemplary combination of those components that would need to be assembled to create the infrastructure in order to provide the tools and services embodied by the present invention. As will be apparent to one skilled in the relevant art(s), all of the components “inside” of the apparatus 120 may be connected and may communicate via a wide or local area network (WAN or LAN).

The apparatus 120 includes application server 132 or a plurality of application servers 132. The application server 132 comprises web application server 138 and a computer server 140 that servers as the application layer of the invention. Yet another server is the File Server 134 which has the purpose of storing and providing digital files to other components of the apparatus 120. Also included is a mail server 142 which represents the asynchronous communication component of the apparatus 120, and sends and receives electronic messages to and from devices 152, 154, 156, and 158 & 102, 104, and 106. Also included is a chat server 144 which represents the synchronous communication component of the apparatus 120, and sends and receives electronic messages to and from devices 152, 154, 156, and 158 & 102, 104, and 106. Also included are the database software 146 and database 148.

The Web application server 138 is a system that sends out data in response to requests from remote browsers (i.e. Users of the apparatus 120). That is, the Web server 138 provides the GUI 108, 110, 112, 114 or provides data to the interfaces 102, 104, 106, 152, 154, 156, and 158 for users of the system in the form of, but not limited to Web pages, interaction device command interfaces, and etc. The apparatus 120 also includes a second switch 150 that allows components of the apparatus to be interconnected in a local area network (LAN) or a wide area network (WAN). Thus, data can be transferred to and from the various components of the apparatus 120.

As will be appreciated by those skilled in the relevant art(s), this configuration of router 122 and switch 124 is flexible and can be omitted in certain embodiments. Additional routers 122 and/or switches 124 can also be added.

The application server 132, the database(s) 146, 148, the mail server 142, and the chat server 144 are shielded from the public Internet 116 through the firewall 136. The firewall 136 is a dedicated gateway machine with special security precaution software. It is typically used, for example, to service Internet 116 connections and dial-in lines and protects the cluster of more loosely administered network elements hidden behind it from external invasion. Firewalls are well known in relevant art(s).

As would be appreciated by those skilled in the relevant art(s), the inclusion of the firewall 136 is flexible and can be omitted in certain embodiments. Additional firewalls 136 can also be added.

The computer server 140 may include a central processing unit (CPU), a random access memory (RAM) temporary storage of information, and a read only memory (ROM) for permanent storage of information. Computer server 140 may be generally controlled and coordinated by operating system software. The operating system controls the allocation of system resources and performs tasks such as processing, scheduling, memory management, networking, and I/O services, among things. Thus, the operating system resident in system memory and executed by CPU coordinates the operation of the other elements of the apparatus 120.

Although the description of the computer server 140 may refer to terms commonly used in describing particular computer servers, description and concepts equally apply to other processing systems including systems having architectures dissimilar to that shown in FIG. 1.

Also included is inter-process communications protocol 150 (IPCP), a set of rules for marshalling and un-marshalling parameters and results. This is the activity that takes place at the point where the control path in the calling and called process enters or leaves the IPCP domain. The IPCP is essentially a set of rules for encoding and decoding information transmitted between multiple processes.

As will be appreciated by those skilled in the relevant art(s), the inclusion of the IPCP 150 is flexible and can be substituted or omitted in certain embodiments.

The apparatus 120 may also include the file server 134 or a plurality of file servers that manage(s) digital files and other human or computer usable files. The file server 134 may be configured separately from the web server 138. This configuration may increase the scalability of the server apparatus 120. Alternatively, the web server 138 and file server 134 can be configured together. Examples of file formats that can be managed by the file server 134 include, but are not limited to, Graphical Interchange Format (“GIF”), Joint Photographics Experts Group (“JPEG”), or MPEG-1 audio layer 3 (MP3), Waveform audio format (WAV), or Moving Picture Experts Group (MPEG).

The mail server 142 is a repository for e-mail messages received from the Internet 116. It also manages the transmission of electronic messages (“electronic mail” or “e-mail”). The mail server 142 consists of a storage area, a set of user definable rules, a list of users and a series of communication modules. Its primary purpose in the present invention is the storage and distribution of e-mail messages to the Internet 116.

The chat server 144 is a repository for instant messages received from the Internet 116. It also manages the transmission of electronic messages (“instant messages” or “IM”). The mail server 144 consists of a storage area, a set of user definable rules, a list of users and a series of communication modules. Its primary purpose in the present invention is the storage and distribution of instant messages to the Internet 116.

The databases 146 and 148 store software, descriptive data, digital files, system data and any other data item required by the other components of the apparatus. The databases may be provided, for example, as a database management system (DBMS), an object-oriented database management system (ODBMS), a relational database management system (e.g. DB2, ACCESS etc.), a file system or another conventional database package. Thus, the databases 146 and 148 can be implemented using object-oriented technology or via text files. Further, the databases 146 and 148 can be accessed via a Structured Query Language (SQL) or other tools, and the like, known to one of ordinary skill in the art.

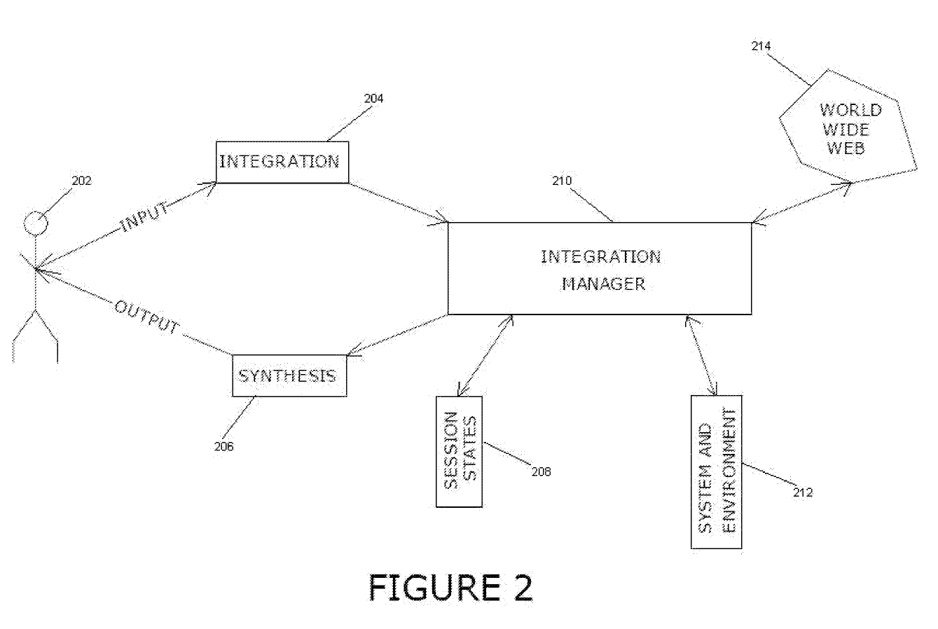

FIG. 2 shows a diagram of model architecture for a multimodal web system. The user 202 interfaces with the system through five components connecting the user 202 and the web 214. The Integration component 204 combines all data produced by inputs received into one unified stream that the interaction manager receives. The component takes care of mixing and disambiguating input, handling the possible contradictions and uncertainties. The Synthesis component 206 does the opposite: from one output stream the interaction manager produces, the component generates output data specific to the output modes available. The Interaction Manager 210 connects all the components together. This involves selection of the interaction type (linear, visual, text-only, or graphical) from the modes it finds connected to the user # or from the data it receives from the system-and-environment component 212. The System and Environment component 212 is in charge of providing values for environmental conditions; CPU speed or type, graphical capabilities, battery and power levels, etc. The Sessions component 208 is in charge of managing how a session with Web data, or applications, can migrate from one modality to another, or between multimodal browsers.

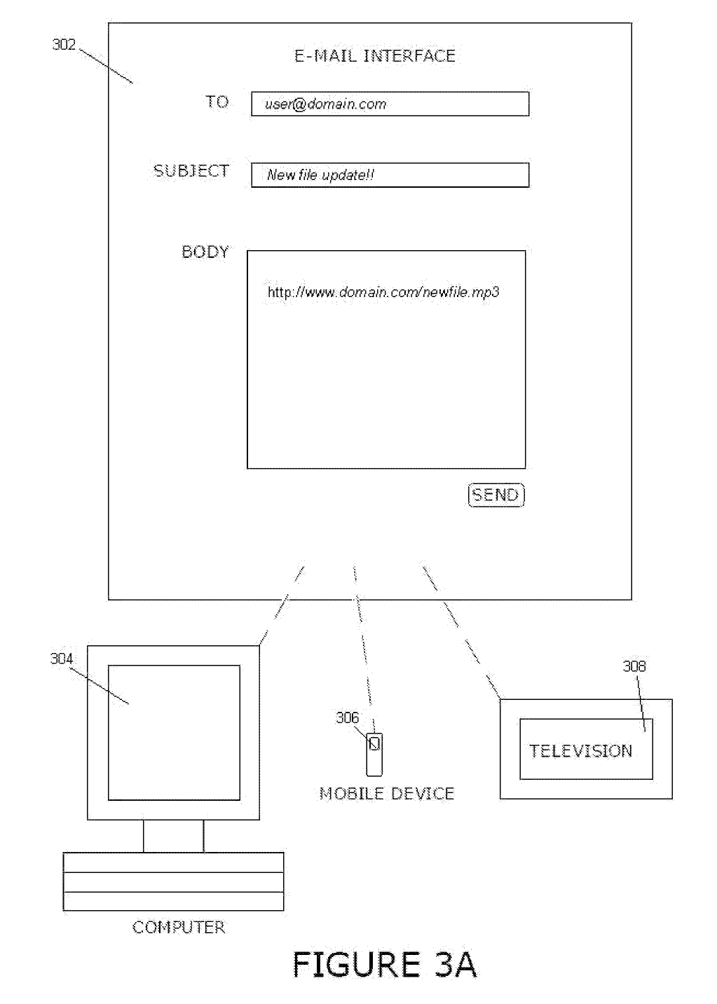

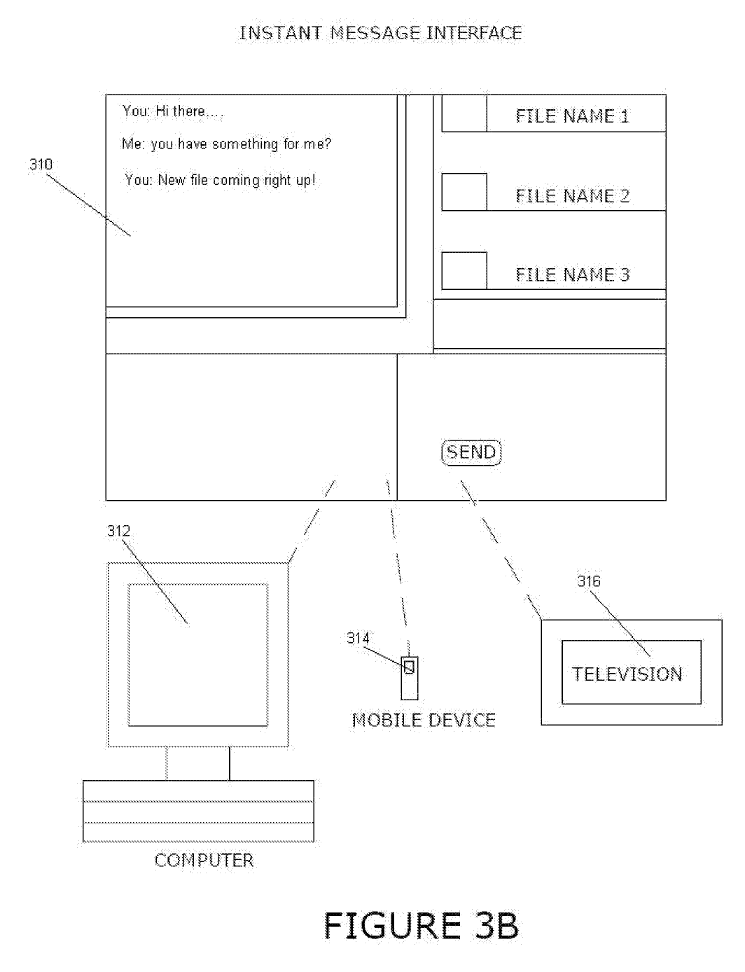

FIG. 3a shows a diagram of a model screen 302 provided to a user through an interface 304, 306, or 308, such as over the internet, that displays fields for user input of data to be associated with a file media content for sharing through an asynchronous communication method. This screen displays an email form for notifying other users of the content specified. This screen includes fields for data entry that are for a users email address, name, subject, and message body text with the content URL or Hyper-Text Link embedded in the message body.

FIG. 3b shows a diagram of a model screen 310 provided to a user through an interface 312, 314, or 316, such as over the internet, that displays an instant messaging interface for allowing users to interact with each other through a synchronous communication method. This screen contains input dialogue and output dialogue windows, and a window for allowing the user to view their currently stored content for direct transfer to the other user engaged in the communication.

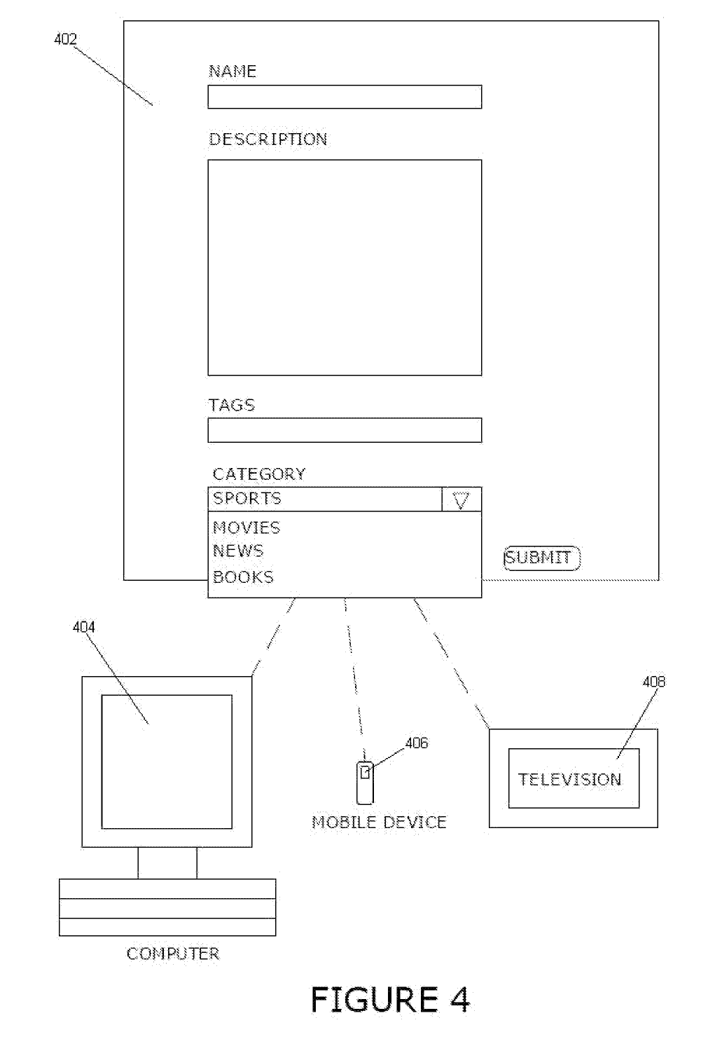

FIG. 4 shows a diagram of a model screen 402 provided to a user through an interface 404, 406, or 408, such as over the Internet, that displays fields for user input of data to be associated with a file media for upload. In this example, There are fields for data entry presented, and these include a name field, for the title of the file media for upload, a description field for describing the content or purpose of the file media, a tag field for associating descriptive data that is available for searching to the file media for upload, and a category drop-down list box for selecting a category by which the file media for upload will be associated. Once a user has selected to enter descriptive data to fields of their choosing whether required or not required, the user may submit this data for association with the uploaded file media.

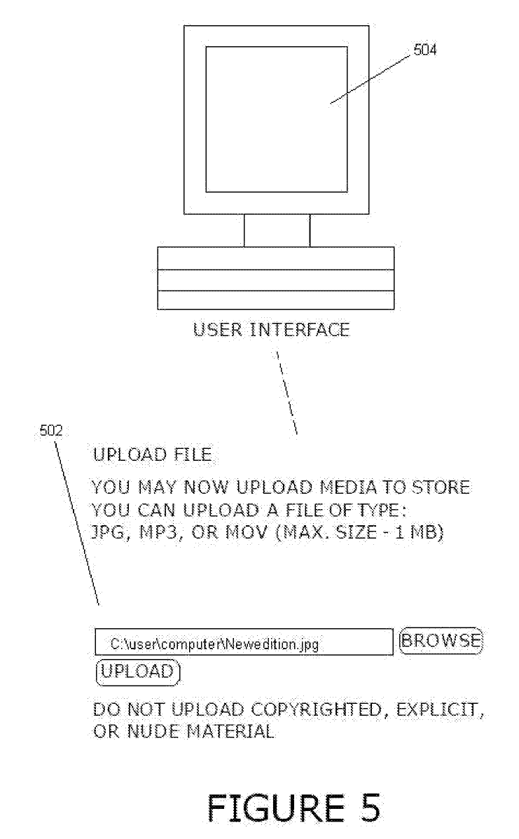

FIG. 5 shows a diagram of a model screen provided to a user through an interface 504, such as over the Internet, that displays file upload controls 502 for browsing the file system of the interface 504 or browsing external storage systems physically, or non-physically connected to said interface 504 to select a file media for upload into the system. This diagram contains upload controls 502, which further contain information the user may need in allowing successful upload of a file to the system. This information for proper file upload may include, but is not limited to, allowed file types for upload, appropriate content types for upload(i.e. Not allowing copyrighted material), and appropriate file sizes allowed for upload, and etc.

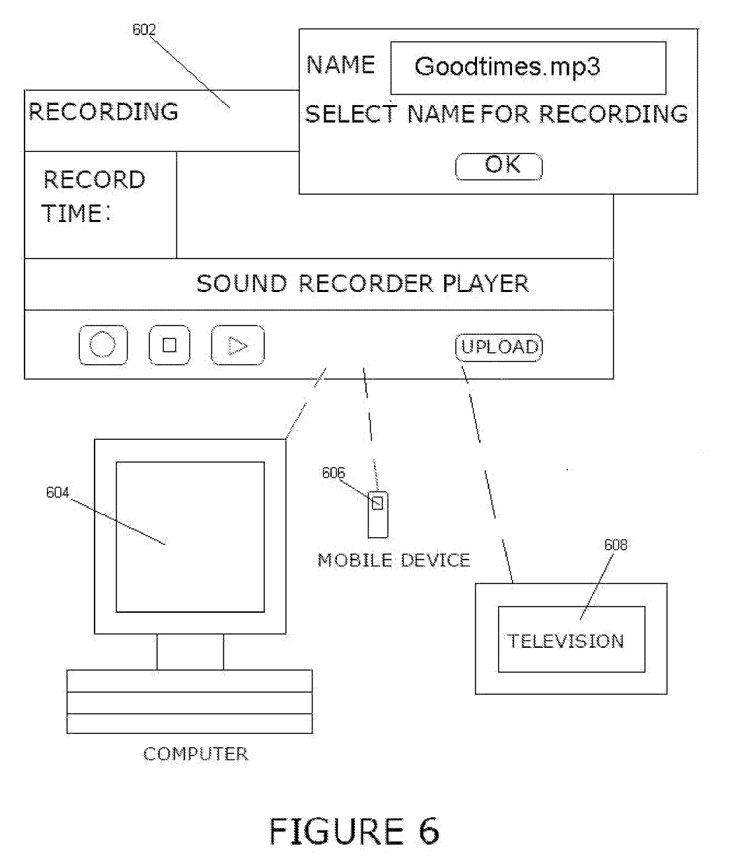

FIG. 6 shows a diagram of a model screen provided to a user through an interface 604, 606, or 608, such as over the Internet, which displays a Media Creation Interface (MCI) # 602. This model screen in particular reveals an MCI 602 for creating audio file media. The MCI 602 contains user controls for the manipulation and creation of feedback media; these controls include play, stop, record, upload controls, user feedback mechanisms and etc.

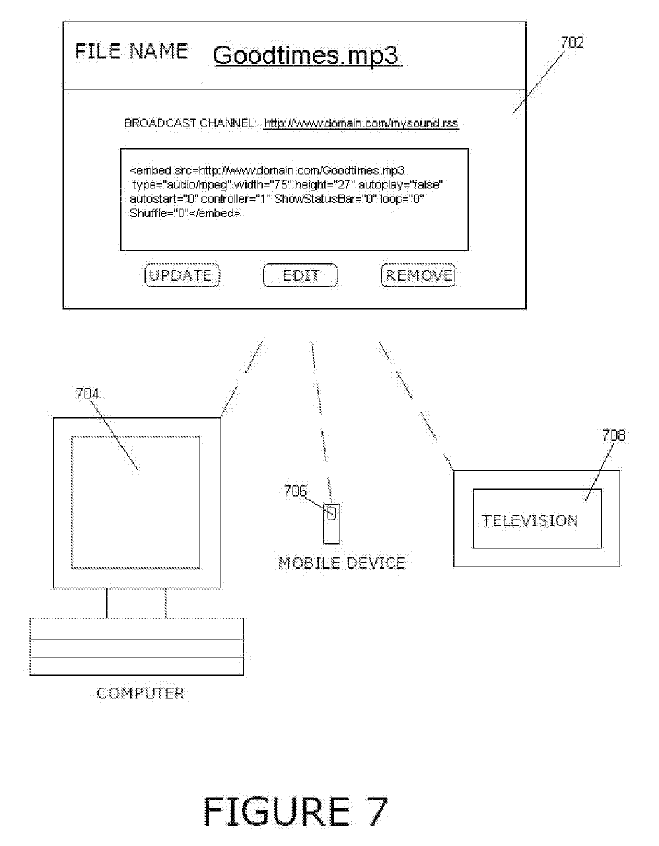

FIG. 7 shows a diagram of a model screen provided to a user through an interface 704, 706, or 708, such as over the Internet, that displays a Hyper-Text Link Information System (HTLIS) 702. This diagram reveals a dynamically generated link for manual distribution that may be played back by the user or may be downloaded to a user's interface file system. The HTLIS 702 may also dynamically generate a link to feed data that may be used to distribute said file media automatically to feed data subscribers. The HTLIS 702 also reveals dynamically generated code for distribution of an associated file media through media player objects or other online applications in other Internet documents. The HTLIS 702 contains controls for updating, editing, and removing dynamically generated links. The HTLIS 702 serves the purpose of seamlessly integrating all the tools a user may need for distribution of file content on an online system.

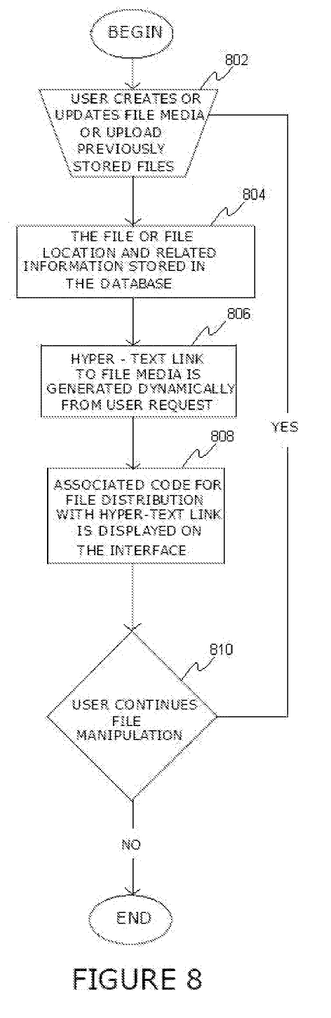

FIG. 8 illustrates a method by which hyper-text links are created in the HTLIS on an on-line system as explained in FIG. 5, with functions from FIG. 4, FIG.3, or FIG.5. At 802, user creates a new file media for upload with functions from FIG. 4 or selects a stored file media from functions of FIG.3 or FIG.5. At 804, the user has selected to upload a file media and that file media's location or file information and related information are stored in the database 148. At 806 through 808, a hyper-text link(s) and associated code to the uploaded file media are generated dynamically or at a user's request. At 810, the user may proceed to add, create, and manipulate more file media in the system wherein steps 802-810 are repeated or the user may now finish said file operations.

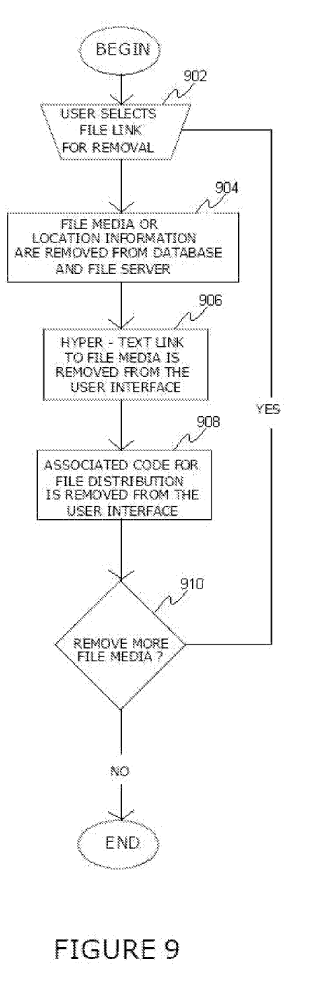

FIG. 9 illustrates a method by which hyper-text links are removed in the HTLIS on an online system as explained in FIG. 5. At 902, a user selects a file media for removal from the system. At 904, the selected file media for removal is deleted from its physical location along with its associated file information and/or location that is stored in the database. At 906 through 908, hyper-text link(s) to media is removed from the HTLIS along with any associated code and/or link(s) for distribution of the said file media. At 910, the user may choose to remove remaining media files stored on the system through the interface following processes 902-910 again or the user may decide not to remove more media files, ending the process flow.

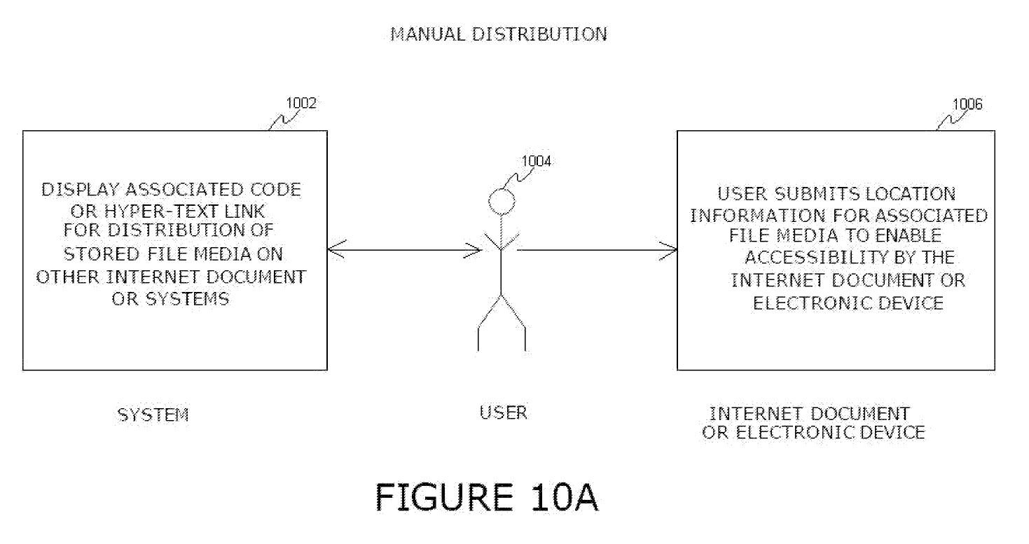

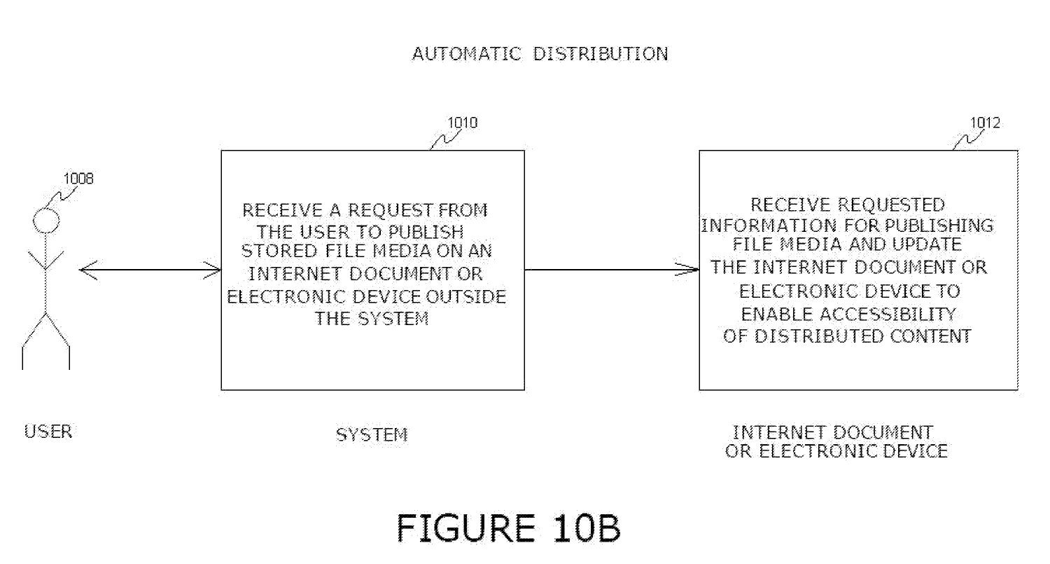

FIG. 10a illustrates a work flow for allowing users to manually distribute files between the system and other online internet systems 1004, online documents, or electronic devices. At 1002 the system has displayed code, methods, or options for distributing a file media. The user 1004 takes this information generated by the system and must interact with the outside online system 1004, internet document 1004, or electronic device 1004 using the information provided by the proposed system at 1002.

FIG. 10b illustrates a work flow for allowing users to automatically distribute file media information between other online systems 1012, online documents 1012, and electronic devices 1012. The user 1008 begins by sending a request to the proposed system 1010 for the distribution of file media information. The proposed system 1010 takes the user 1008 information request, and interfaces with the other online system 1012, internet document, or electronic device 1012, to distribute the requested file media information to the system 1012.

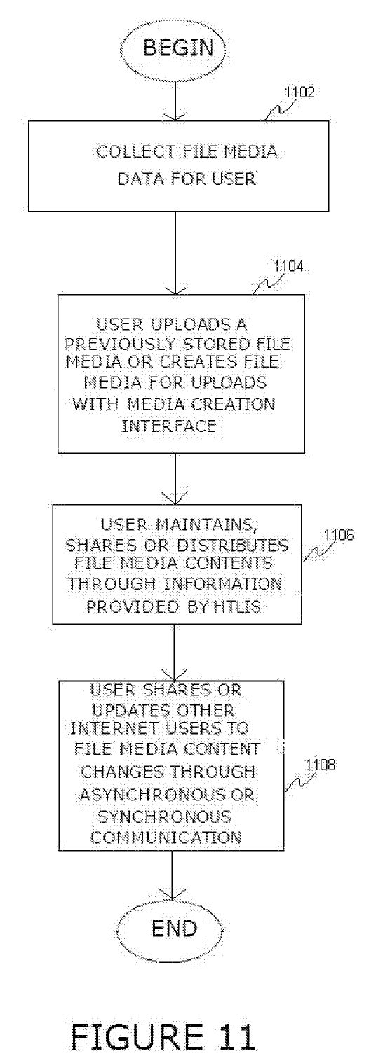

FIG. 11 illustrates a method for allowing a user to store a file media on an online storage system and manipulate information about stored file media on the system for sharing or distribution. At 1102, data is collected about a user's currently stored file media or lack thereof. At 1104, user may choose to create a new file media for upload through the MCI or use a pre-created file media for upload. At 1106, user may view, distribute, share, or remove file media through information given from the HTLIS. At 1108, user may share or update other internet users to file media content changes through asynchronous or synchronous communications means.

From the description above, a number of advantages of the invention become evident. Users that previously were not able to store media on an online storage system because of lack of a file media for upload, now have the option to create a new file media for upload on the storage system. This lowers the barrier to entry and facilitates a user's effective use of an online storage system by providing a MCI for the creation of media to upload. Another means by which the system lowers the barrier to entry for accessibility and use is through the employment of a multimodal architecture. The use of a multimodal architecture is essential as a user's ability to access the internet moves from a traditional computer centric model to a more modular model of access devices through the proliferation of electronic mobile devices, and electronic media devices that can interface and access the web. A multimodal architecture will enable the system to provide dynamic interaction and access depending on the device type that interfaces with the system. This invention also facilitates a user's distribution and sharing of uploaded file media by dynamically generating distribution tools by which a user can use to share their file media with other Internet users.

Thus, with the present system, individuals can greatly improve breadth and coverage of potential audiences to their file media through the dynamically generated tools for distribution and sharing provided by the system. The “feed” dynamic of the system exemplifies this, as users may automatically update an audience to file media changes as file media's are added or removed by the system. The integration of asynchronous and synchronous communication tools compliments the distribution tools of this system by providing a user capability for the direct transfer of content to other users, as well as, user interaction and presents a clear advantage over any existing “online hard drive”, “online storage system”, “online file host system”, and the like.

While various embodiments of the invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the following claims and their equivalents.

I claim:

1. A method for accessing an on-line storage system that enables a user the abilities to create file media, for upload retrieval, distribution and sharing purposes.

2. A method according to claim 1 where system allows a user to upload previously stored and previously created media or upload file media created by the user on the system.

3. A method according to claim 1 where system embodies architecture for allowing multimodal user interfaces and presentation depending upon the device type that accesses the system.

4. A method according to claim 1 that incorporates the use of asynchronous and synchronous communications tools for allowing users to share, update peers to content changes, and socialize with other users.

5. A method that involves a media creation interface for the creation of new media files through user inputs and interfaces interacting with the system.

6. A method according to claim 5 where said user inputs and interfaces for media creation may be connected physically, non-physically, or integrated into the system interface for creation of media.

7. A method according to claim 5 where system skips the transfer of a file from an off-line storage medium, to an on-line storage medium through the media creation interface.

8. A method according to claim 5 where the media creation interface may be integrated into the system or may be served as a downloadable off-line or on-line client that allows the creation of media files for direct transfer of media files to an on-line storage medium or provides methods of storage off-line for later on-line file transfer.

9. A method for a descriptive information collection system to facilitate the sharing of or distribution of media files.

10. A method that involves a hyper-text link information system to facilitate sharing or distribution of media files.

11. A method according to claim 10 where information is provided to the user or created dynamically for distribution of the media file on-line through a file media compatible object or interface.

12. A method according to claim 10 where information is provided to the user or created dynamically for distribution of the media-file on-line through a content feeding system.

13. System involves means for publishing or distribution of file media content to other Internet documents or online documents through automatic or manual methods.

14. System involves a file system for the physical storage of files or storage of file information.

15. A method according to claim 14 where said file system may involve folders, tagging, facets or other file system schema types or hybrids.

16. A method according to claim 14 where said file system may involve a multidimensional hierarchical file system.

17. A method according to claim 14 where said file system may involve a unidimensional hierarchical file system.

18. System involves a database for the physical storage of files or storage of file information.

19. A method according to claim 19 where database schema may be comprised of any current or future database schema, models, or hybrids.
